(19) United States
(12) Patent Application Publication
(10) Pub. No.: US 2019/0300659 A1
(43) Pub. Date: Oct. 3, 2019

(54) LIQUID-CONTAINING POLYOLEFIN MASTER BATCHES AND METHODS

(71) Applicant: EQUISTAR CHEMICALS, LP, Houston, TX (US)

(72) Inventors: CINDY L. FLENNIKEN, CLARKSVILLE, OH (US); CHUN D. LEE, CINCINNATI, OH (US)

(73) Assignee: EQUISTAR CHEMICALS, LP, HOUSTON, TX (US)

(21) Appl. No.: 16/374,313

(22) Filed: Apr. 3, 2019

Related U.S. Application Data
(60) Provisional application No. 62/652,062, filed on Apr. 3, 2018.

(51) Int. Cl. C08J 3/22; C08F 210/06; C08K 5/54

(52) U.S. Cl. CPC C08J 3/226; C08K 5/5403; C08F 210/06

(57) ABSTRACT

Provided herein are liquid-containing masterbatches and methods of forming liquid-containing masterbatches. The methods may include providing a mixture including an organosilane and porous particles; and heating the mixture at a temperature effective to adsorb at least a portion of the organosilane to one or more surfaces of the porous particles to form a polyolefin master batch. An organosilane may be present in a polyolefin master batch in an amount ranging from about 10% to about 50% by weight of the polyolefin master batch, and the porous particles may include [1] polypropylene, [2] a copolymer including (i) a propylene monomer and (ii) at least one of an ethylene monomer and a butene monomer, or [3] a combination thereof.

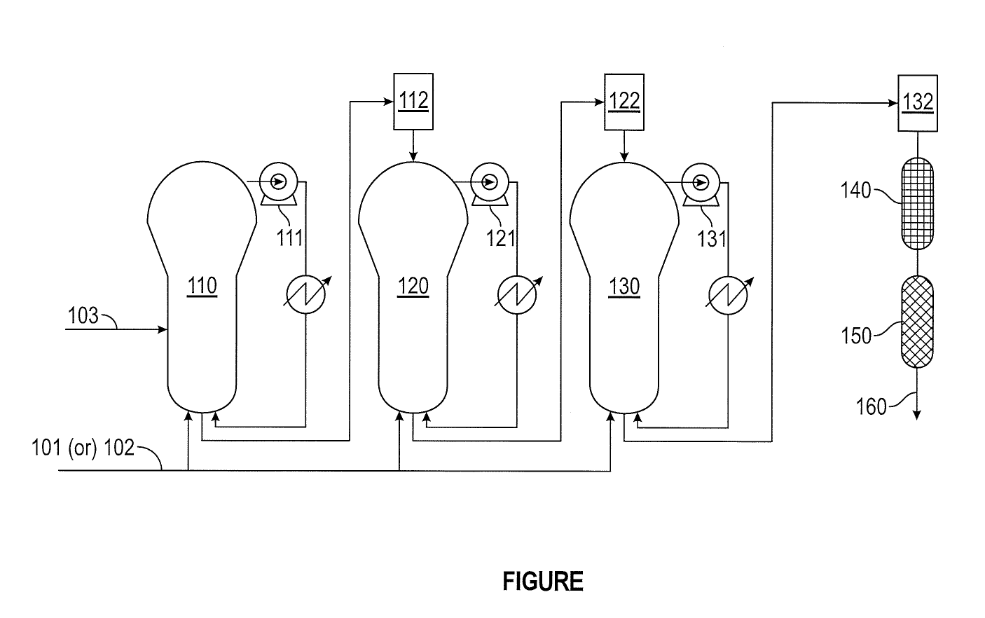

### CROSS-REFERENCE TO RELATED APPLICATIONS

This application is the Non-Provisional patent application, which claims benefit of priority to U.S. Provisional Application No. 62/652,062, filed Apr. 3, 2018, the contents of which are incorporated herein by reference in their entirety.

### BACKGROUND

Liquid may be incorporated into polymer compositions by injection or spray. Alternatively, the liquid may be carried in a master batch and compounded (or mixed or blended) with the polymer composition.

XP400 low density polyethylene (“LDPE”) (available from 3M, Company in Germany) has been used for peroxide adsorption applications. In various embodiments, the XP400 was modified to increase its pores so that it could act as a carrier of the peroxide. Additional manufacturing steps may have used to increase the pores of XP400. In the additional manufacturing step(s) carbon dioxide (an azo agent), or other blowing agent, was used to introduce pores into the molten polymer followed by re-pelletization, and then a peroxide adsorption step. The porous LPDE pellets could be filled with liquid, but may have high levels of fines and may be friable.

### BRIEF SUMMARY

Provided herein are polyolefin master batches and methods of forming polyolefin master batches. The methods provided herein may permit the incorporation of liquids, including liquids having one or more hazardous characteristics, into a robust carrier resin. The polyolefin master batches provided herein may be introduced via common material transfer and/or conveyor systems, such as standard feeders or satellite extruders. In some embodiments, the polyolefin master batches include porous particles that in various embodiments do not have additional manufacturing step(s) to introduce porosity.

In one aspect, methods of forming polyolefin master batches are provided. In some embodiments, the methods include providing a mixture comprising an organosilane and porous particles; and heating the mixture at a temperature effective to adsorb at least a portion of the organosilane to one or more surfaces of the porous particles to form a polyolefin master batch. The organosilane may be present in the polyolefin master batch in an amount ranging from about 10% to about 50% by weight of the polyolefin master batch. The porous particles may include [1] polypropylene, [2] a copolymer comprising (i) a propylene monomer and (ii) at least one of an ethylene monomer and a butene monomer, or [3] a combination thereof.

In one aspect, polyolefin master batches that include an organosilane are provided. In some embodiments, the polyolefin master batches include porous particles and an organosilane adsorbed to the porous particles. The organosilane may be present in an amount ranging from about 10% to about 50% by weight, based on the combined weight of the porous particles and the organosilane. The porous particles may include [1] polypropylene, [2] a copolymer comprising (i) a propylene monomer and (ii) at least one of an ethylene monomer and a butene monomer, or [3] a combination thereof.

In some embodiments, the polyolefin master batches include porous particles and vinylsilane adsorbed to the porous particles. The vinylsilane may be present in an amount ranging from about 10% to about 50% by weight, based on the combined weight of the porous particles and the vinylsilane. The porous particles may have a porosity of about 15% to about 35%. The porous particles may include a copolymer that includes (i) a propylene monomer and (ii) at least one of an ethylene monomer and a butene monomer.

### BRIEF DESCRIPTION OF THE DRAWINGS

The FIGURE depicts an embodiment of a process for preparing polypropylene polymers and copolymers.

### DETAILED DESCRIPTION

Provided herein are methods of forming polyolefin master batches, and polyolefin master batches that include porous particles and an organosilane.

### Polyolefin Master Batches

In one aspect, polyolefin master batches including porous particles and an organosilane are provided herein. In some embodiments, the polyolefin master batches include porous particles and an organosilane adsorbed to the porous particles.

In some embodiments, the polyolefin master batches include porous particles and an organosilane adsorbed to the porous particles, wherein the organosilane is present in an amount ranging from about 10% to about 50% by weight, based on the combined weight of the porous particles and the organosilane. In some embodiments, the polyolefin master batches include porous particles and an organosilane adsorbed to the porous particles, wherein the porous particles have a porosity of about 15% to about 35%. In some embodiments, the polyolefin master batches include porous particles and an organosilane adsorbed to the porous particles, wherein the porous particles include [1] polypropylene, [2] a copolymer including (i) a propylene monomer and (ii) at least one of an ethylene monomer and a butene monomer, or [3] a combination thereof.

In some embodiments, the polyolefin master batches include porous particles and an organosilane adsorbed to the porous particles, wherein the organosilane is present in an amount ranging from about 10% to about 50% by weight, based on the combined weight of the porous particles and the organosilane; the porous particles have a porosity of about 15% to about 35%; and the porous particles include [1] polypropylene, [2] a copolymer including (i) a propylene monomer and (ii) at least one of an ethylene monomer and a butene monomer, or [3] a combination thereof.

In some embodiments, the polyolefin master batches include porous particles and vinylsilane adsorbed to the porous particles, wherein the vinylsilane is present in an amount ranging from about 10% to about 50% by weight, based on the combined weight of the porous particles and the vinylsilane, and wherein the porous particles have a porosity of about 15% to about 35%, and include a copolymer comprising (i) a propylene monomer and (ii) at least one of an ethylene monomer and a butene monomer.

### Methods

In one aspect, methods of forming polyolefin master batches are provided. In some embodiments, the methods include providing a mixture comprising an organosilane and porous particles, and heating the mixture at a temperature effective to adsorb at least a portion of the organosilane to one or more surfaces of the porous particles to form a polyolefin master batch.

In some embodiments, the temperature effective to adsorb the organosilane to one or more surfaces of the porous particles is about 60° F. to about 150° F. The “temperature effective to adsorb the organosilane to one or more surfaces of the porous particles” is the temperature setting of a heating apparatus used to apply the temperature to the components. In some embodiments, the temperature effective to adsorb the organosilane to one or more surfaces of the porous particles is about 90° F. to about 150° F. In some embodiments, the temperature effective to adsorb the organosilane to one or more surfaces of the porous particles is about 100° F. to about 150° F. In some embodiments, the temperature effective to adsorb the organosilane to one or more surfaces of the porous particles is about 110° F. to about 150° F. In some embodiments, the temperature effective to adsorb the organosilane to one or more surfaces of the porous particles is about 120° F. to about 150° F. In some embodiments, the temperature effective to adsorb the organosilane to one or more surfaces of the porous particles is about 130° F. to about 150° F. In some embodiments, the temperature effective to adsorb the organosilane to one or more surfaces of the porous particles is about 140° F. to about 150° F. In some embodiments, the temperature effective to adsorb the organosilane to one or more surfaces of the porous particles is about 60° F. to about 130° F. In some embodiments, the temperature effective to adsorb the organosilane to one or more surfaces of the porous particles is about 60° F. to about 120° F. In some embodiments, the temperature effective to adsorb the organosilane to one or more surfaces of the porous particles is about 80° F. to about 120° F.

In some embodiments, the methods also include tumbling the mixture. As used herein, the term “tumbling” refers to the application of any type of agitating force to the mixture, including, but not limited to, stirring, shaking, rotating, etc. The tumbling may overlap at least partially with the heating of the mixture, or the heating of the mixture and the tumbling may be performed separately. In some embodiments, the methods include tumbling the mixture and heating the mixture to a temperature effective to adsorb the organosilane to one or more surfaces of the porous particles, and the temperature is about 80° F. to about 150° F., about 90° F. to about 150° F., about 100° F. to about 150° F., about 110° F. to about 150° F., about 120° F. to about 150° F., about 130° F. to about 150° F., or about 140° F. to about 150° F.

### Organosilane

In some embodiments, the organosilane is present in a polyolefin master batch in an amount ranging from about 10% to about 50% by weight of the polyolefin master batch. In some embodiments, the organosilane is present in a polyolefin master batch in an amount ranging from about 10% to about 40% by weight of the polyolefin master batch. In some embodiments, the organosilane is present in a polyolefin master batch in an amount ranging from about 10% to about 30% by weight of the polyolefin master batch. In some embodiments, the organosilane is present in a polyolefin master batch in an amount ranging from about 15% to about 25% by weight of the polyolefin master batch. In some embodiments, the organosilane is present in a polyolefin master batch in an amount ranging from about 17% to about 23% by weight of the polyolefin master batch. In some embodiments, the organosilane is present in a polyolefin master batch in an amount ranging from about 19% to about 22% by weight of the polyolefin master batch.

Any organosilane may be used in the methods or present in the polyolefin master batches provided herein, including a scorch retardant organosilane. As used herein, the term “organosilane” refers to a silane derivative that includes at least one carbon-silicon covalent bond. The organosilane may be a liquid organosilane. Therefore, the mixtures provided herein may include a liquid volume of the organosilane. In some embodiments, the organosilane includes a vinylsilane.

### Porous Particles

Any porous particles to which an organosilane can adsorb may be used in the methods or present in the polyolefin master batches provided herein. As used herein, the phrase “porous particles” may refer to particles having voids. The porous particles may have any shape and/or size. In some embodiments, the porous particles are substantially spherical. The porous particles may include thermoplastic porous particles. In some embodiments, the porous particles are substantially spherical thermoplastic porous particles.

As used herein, the phrase “substantially spherical” may refer to particles having a ratio between a greater axis and a smaller axis that is less than or equal to 1.5, or less than or equal to 1.3.

In the present description, the term “thermoplastic polymer” may refer to a polymer that softens when exposed to heat and returns to its original condition when cooled to room temperature.

The porous particles may have any porosity that permits the formation of the polyolefin master batches provided herein. In some embodiments, the porous particles have a porosity (% vol.) of about 15% to about 50%. In some embodiments, the porous particles have a porosity (% vol.) of about 15% to about 35%. In some embodiments, the porous particles have a porosity (% vol.) of about 15% to about 25%. In some embodiments, the porous particles have a porosity (% vol.) of about 20% to about 25%. In some embodiments, the porous particles have a porosity (% vol.) of about 20% to about 30%, about 21% to about 29%, or about 21% to about 27%. In some embodiments, the porous particles have a porosity (cc/g) of about 0.3 to about 0.55, about 0.35 to about 0.5, or about 0.35 to about 0.48.

In some embodiments, the porous particles include [1] polypropylene, [2] a copolymer including (i) a propylene monomer and (ii) at least one of an ethylene monomer and a butene monomer, or [3] a combination thereof.

In some embodiments, the porous particles include polypropylene. For example, the porous particles may include a polypropylene random copolymer. In some embodiments, the porous particles include a copolymer including (i) a propylene monomer and (ii) at least one of an ethylene monomer and a butene monomer. In some embodiments, the porous particles include a copolymer including a propylene monomer and an ethylene monomer. In some embodiments, the porous particles include a copolymer including a propylene monomer and a butene monomer. In some embodiments, the porous particles include a copolymer including a propylene monomer, an ethylene monomer, and a butene monomer. In some embodiments, the porous particles include polypropylene and a copolymer including a propylene monomer and an ethylene monomer. In some embodiments, the porous particles include polypropylene and a copolymer including a propylene monomer and a butene monomer. In some embodiments, the porous particles include polypropylene and a copolymer including a propylene monomer, an ethylene monomer, and a butene monomer. In some embodiments, the porous particles include a substantially spherical polypropylene reactor sphere.

The copolymer including (i) a propylene monomer, and (ii) at least one of an ethylene monomer and a butene monomer may include any percentages of the propylene and the ethylene monomer and/or butene monomer. In some embodiments, the propylene monomer is present in the copolymer in an amount of at least 50%, by weight, based on the weight of the copolymer. In some embodiments, the propylene monomer is present in the copolymer in an amount of at least 75%, by weight, based on the weight of the copolymer. In some embodiments, the propylene monomer is present in the copolymer in an amount of at least 85%, by weight, based on the weight of the copolymer. In some embodiments, the propylene monomer is present in the copolymer in an amount of at least 90%, by weight, based on the weight of the copolymer. In some embodiments, the propylene monomer is present in the copolymer in an amount of at least 95%, by weight, based on the weight of the copolymer.

The phrase “butene monomer”, as used herein, includes 1-butene monomers, 2-butene monomers, 1,3-dibutene monomers, isobutylene, and combinations thereof. The 2-butene monomers may include the cis isomer, the trans isomer, or a combination thereof.

In some embodiments, the porous particles are in the form of a powder, such as a reactor grade powder. In some embodiments, the porous particles are in the form of a powder, such as a reactor grade powder, and have a porosity (% vol.) of about 23%. As used herein, the term “powder” may refer to particles having an average largest dimension of about 1 mm or less.

The porous particles may be of any size. In some embodiments, the porous particles have an average largest dimension of about 0.1 mm to about 10 mm, or about 0.1 mm to about 5 mm. In some embodiments, the porous particles have an average largest dimension of about 0.5 mm to about 10 mm, about 1 mm to about 7 mm, about 2 mm to about 6 mm, or about 3 mm. In some embodiments, the porous particles have an average largest dimension of about 1 mm, about 2 mm, about 3 mm, about 4 mm, about 5 mm, about 6 mm, or about 7 mm. The porous particles may be substantially uniform in size, or the porous particles may include particles having a plurality of sizes. When the porous particles are spherical or substantially spherical, the phrase “average largest dimension” refers to the “average diameter” of the porous particles.

The polypropylene polymers and copolymers may be prepared by any known techniques. In some embodiments, the polypropylene polymers and copolymers are prepared using the apparatuses and process depicted at the FIGURE. The FIGURE depicts a process 100 for preparing polypropylene polymers or copolymers. Propylene 101 or a mixture of monomers 102 is provided to three gas phase reactors (110, 120, 130) that are connected in series. A catalyst 103 is provided to the first gas phase reactor 110. Each of the gas phase reactors (110, 120, 130) is associated with a fluidization compressor (111, 121, 131). A first degassing is achieved with a first bag filter and lock hoppers (112) arranged between the first gas phase reactor 110 and the second gas phase reactor 120. A second degassing is achieved with a second bag filter and lock hoppers (122) arranged between the second gas phase reactor 120 and the third gas phase reactor 130. A third degassing is achieved with a third bag filter 132. After the third degassing, the stream is provided to a steamer 140, and then a dryer 150. The dryer 150 may include a flow of nitrogen gas. The polymerized product 160 is collected from the dryer 150.

In some embodiments, the porous particles include a substantially spherical polypropylene reactor sphere. In some embodiments, the porous particles include a polypropylene random copolymer. The porous particles, such as a polypropylene random copolymer or a polypropylene reactor sphere, may have a density of about 0.6 g/cm to about 1.2 g/cm, about 0.7 g/cm to about 1.1 g/cm, about 0.8 g/cm to about 1 g/cm, or about 0.9 g/cm (as determined by ISO 1183). The porous particles, such as a polypropylene random copolymer or a polypropylene reactor sphere, may have a melt flow rate of about 4 g/10 min. to about 21 g/10 min., about 5 g/10 min., or about 20 g/10 min. (as determined by ISO 1133, 230° C./2.16 g). In some embodiments, the porous particles have a porosity (% vol.) of about 20% to about 30%, about 21% to about 27%, about 22%, about 23%, about 24%, about 25%, or about 26%. In some embodiments, the porous particles have a porosity (cc/g) of about 0.35 to about 0.48, about 0.36, about 0.37, about 0.38, about 0.39, about 0.40, about 0.41, about 0.42, about 0.43, about 0.44, about 0.45, about 0.46, or about 0.47. In some embodiments, the porous particles have a C2 (ethylene) content of about 1% to about 5%, about 2% to about 4%, or about 3%, by weight, based on the weight of the porous particles. In some embodiments, the porous particles include a polypropylene random copolymer made with a Ziegler-Natta catalyst, such as “ZN107”, as disclosed at U.S. Pat. No. 5,221,651, which is incorporated herein by reference. In some embodiments, the porous particles include HIFAX® CA 7153S carrier resin (LyondellBasell Industries, USA). In some embodiments, the porous particles include HIFAX® CA 7153S carrier resin (LyondellBasell Industries, USA) having a melt flow rate of about 20 g/10 min., or about 5 g/10 min. (as determined by ISO 1133, 230° C./2.16 g).

ISO 1133 is entitled “Plastics—Determination of the Melt Mass-Flow Rate (MFR) and the Melt Volume-Flow Rate (MVR) of Thermoplastics.” The term “ISO 1133” as used herein refers to the test method for the determination of the melt mass-flow rate (MFR) and the melt volume-flow rate (MVR) by extruding molten material from the barrel of a plastometer under preset conditions of temperature and load.

ISO 1183 is entitled “Methods for Determining the Density of Non-Cellular Plastics.” The term “ISO 1183” as used herein refers to the test method for the determination of the density of non-cellular molded or extruded plastics in void-free form. In this gradient column method, density gradient columns are columns containing a mixture of two liquids, the density in the column increasing uniformly from top to bottom.

The polypropylene polymers or copolymers can be made by a variety of processes including batch and continuous processes using single, staged, or sequential reactors, slurry, solution, and fluidized bed processes and one or more catalysts including for example, heterogeneous and homogeneous systems and Ziegler, Phillips, metallocene, single-site, and constrained geometry catalysts to produce polymers having different combinations of properties.

The polypropylene polymers or copolymers may be made by processes that include contacting one or more monomers with a catalyst, such as a Ziegler-Natta catalyst. Useful Ziegler-Natta catalysts may include (i) a solid catalyst component comprising a titanium compound having at least one titanium-halogen bond, and an electron-donor compound, both supported on a magnesium halide in active form; (ii) a co-catalyst component comprising an organoaluminum compound, such as an aluminum alkyl compound; and optionally, (iii) an external electron donor. Examples of such catalysts are known to those of ordinary skill in the art, with such catalysts being disclosed, for example, in U.S. Pat. Nos. 5,221,651, 4,399,054, 4,472,524, the disclosures of which are hereby incorporated by reference.

The solid catalyst component of the Ziegler-Natta catalyst may act as an internal electron donor, and may be a compound selected from the group consisting of ethers, ketones, lactones, compounds containing N, P and/or S atoms, and esters of mono- and dicarboxylic acids. Particularly suitable electron-donor compounds include, but are not limited to, phthalic acid esters, such as diisobutyl, dioctyl, diphenyl and benzylbutyl phthalate Other electron-donors particularly suitable are 1,3-diethers of the following formula:

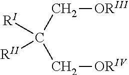

where R^{I} and R^{II} are the same or different and are C₁₋₁₈ alkyl, C₃₋₁₈ cycloalkyl or C₇-C₁₈ aryl radicals; R^{III} and R^{IV} are the same or different and are C₁-C₄ alkyl radicals; or are the 1,3-diethers in which the carbon atom in position 2 belongs to a cyclic or polycyclic structure made up of 5, 6 or 7 carbon atoms and containing two or three unsaturations. Ethers of this type are described in, for example, published European Patent Application Nos. 0361493 and 0728769, each of which is incorporated herein in pertinent part. Representative examples of these diethers include 2-methyl-2-isopropyl-1,3-dimethoxypropane, 2,2-diisobutyl-1,3-dimethoxypropane, 2-isopropyl-2-cyclopentyl-1,3-dimethoxypropane, 2-isopropyl-2-isoamyl-1,3-dimethoxypropane, and 9,9-bis(methoxymethyl) fluorene.

The solid catalyst component may be prepared according to various methods. For example, a MgCl₂.nROH adduct (in particular in the form of spheroidal particles) wherein n is from 1 to 3 and ROH is ethanol, butanol or isobutanol, may be reacted with an excess of TiCl₄ containing the electron-donor compound. The reaction temperature may be from 80° C. to 120° C. The solid is then isolated and reacted once more with TiCl₄, in the presence or absence of the electron-donor compound, after which it is separated and washed with aliquots of a hydrocarbon until at least a majority of the chlorine ions have disappeared.

In the solid catalyst component the titanium compound, expressed as Ti, may be present in an amount from 0.5 to 10% by weight. The quantity of electron-donor compound which remains fixed on the solid catalyst component may be 5 to 20% by mols with respect to the magnesium dihalide. The titanium compounds which can be used for the preparation of the solid catalyst component are, for example, titanium halides and titanium halogen alcoholates. Titanium tetrachloride is particularly useful.

The reactions described above may result in the formation of a magnesium halide in active form. Other reactions are known in the literature, which cause the formation of magnesium halide in active form starting from magnesium compounds other than halides, such as magnesium carboxylates. The active form of magnesium halide in the solid catalyst component can be recognized by the fact that in the X-ray spectrum of the catalyst component, the maximum intensity reflection appearing in the spectrum of the nonactivated magnesium halide (having a surface area smaller than 3 m²/g) is no longer present, but in its place there is a halo with the maximum intensity shifted with respect to the position of the maximum intensity reflection of the nonactivated magnesium dihalide, or by the fact that the maximum intensity reflection shows a width at half-peak at least 30% greater than the one of the maximum intensity reflection which appears in the spectrum of the nonactivated magnesium halide. The most active forms generally are those where the above-mentioned halo appears in the X-ray spectrum of the solid catalyst component. Among magnesium halides, the magnesium chloride is generally very useful. In the case of the most active forms of magnesium chloride, the X-ray spectrum of the solid catalyst component shows a halo instead of the reflection which in the spectrum of the nonactivated chloride appears at 2.56 Å.

The Al-alkyl compounds used as co-catalysts as disclosed herein can comprise or can be selected from the Al-trialkyls, such as Al-triethyl, Al-triisobutyl, Al-tri-n-butyl, and linear or cyclic Al-alkyl compounds containing two or more Al atoms bonded to each other by way of O or N atoms, or SO₄ or SO₃ groups. The Al-alkyl compound may be used in such a quantity that the Al/Ti ratio can be from 1 to 1000.

The electron-donor compounds that can be used as external donors include aromatic acid esters such as alkyl benzoates, and in particular silicon compounds containing at least one Si—OR bond, where R is a hydrocarbon radical. Examples of silicon compounds include, but are not limited to, (tert-butyl)₂Si(OCH₃)₂, (cyclohexyl)(methyl)Si(OCH₃)₂, (phenyl)₂Si(OCH₃)₂ and (cyclopentyl)₂Si(OCH₃)₂. Further, 1,3-diethers having the formulae described above can also be used. If the internal donor is one of these diethers, the external donors can be omitted if desired.

The molecular weight of the polypropylene polymers and copolymers may be regulated using known molecular weight regulators such as, for example, hydrogen.

The whole polymerization process, which can be continuous or batch, can be performed according to known techniques and operating in liquid phase, optionally in the presence of an inert diluent, or in the gas phase, or by mixed liquid-gas techniques. Carrying out the polymerization in the gas phase is particularly useful, and there may not be a need for intermediate steps except for the possible degassing of unreacted monomers. Reaction time, pressure and temperature relative to the two steps are not critical, however it may be advantageous if the temperature is from about 20° C. to about 100° C. The pressure can be atmospheric or higher.

If desired, the catalyst can be pre-contacted with a small amount of a monomer in a prepolymerization step using techniques and apparatus that are well known to one of ordinary skill in the art.

Other embodiments of the methods and polyolefin master batches provided herein include the following:

### Embodiment 1

A method of forming a polyolefin master batch, the method comprising providing a mixture comprising an organosilane and porous particles; and heating the mixture at a temperature effective to adsorb the organosilane to one or more surfaces of the porous particles to form a polyolefin master batch; wherein the organosilane is present in the polyolefin master batch in an amount ranging from about 10% to about 50% by weight of the polyolefin master batch, and the porous particles comprise [1] polypropylene, [2] a copolymer comprising (i) a propylene monomer and (ii) at least one of an ethylene monomer and a butene monomer, or [3] a combination thereof.

### Embodiment 2

The method of embodiment 1, wherein the porous particles are in the form of a reactor grade powder having a porosity of about 23% or greater.

### Embodiment 3

The method of embodiment 1, wherein the porous particles have a porosity of about 15% to about 50%.

### Embodiment 4

The method of embodiment 1, wherein the porous particles have a porosity of about 15% to about 35%.

### Embodiment 5

The method of embodiment 1, wherein the porous particles have a porosity of about 15% to about 25%.

### Embodiment 6

The method of embodiment 1, wherein the porous particles have a porosity of about 20% to about 25%.

### Embodiment 7

The method of any one of embodiments 1-6, wherein the organosilane is present in the polyolefin master batch in an amount ranging from about 10% to about 40% by weight of the polyolefin master batch.

### Embodiment 8

The method of any one of embodiments 1-6, wherein the organosilane is present in the polyolefin master batch in an amount ranging from about 10% to about 30% by weight of the polyolefin master batch.

### Embodiment 9

The method of any one of embodiments 1-8, wherein the organosilane comprises a vinylsilane.

### Embodiment 10

The method of any one of embodiments 1-9, wherein the organosilane comprises DYNASYLAN® 9116 (Evonik, USA) liquid vinylsilane.

### Embodiment 11

The method of any one of embodiments 1-10, wherein the temperature is about 80° F. to about 150° F.

### Embodiment 12

The method of any one of embodiments 1-11, wherein the method further comprises tumbling the mixture.

### Embodiment 13

The method of any one of embodiments 1-12, wherein the porous particles comprise HIFAX® CA 7153 S (LyondellBasell Industries, USA) carrier resin.

### Embodiment 14

A polyolefin master batch comprising porous particles and an organosilane adsorbed to the porous particles, wherein the organosilane is present in an amount ranging from about 10% to about 50% by weight, based on the combined weight of the porous particles and the organosilane, and the porous particles comprise [1] polypropylene, [2] a copolymer comprising (i) a propylene monomer and (ii) at least one of an ethylene monomer and a butene monomer, or [3] a combination thereof.

### Embodiment 15

The polyolefin master batch of embodiment 14, wherein the porous particles comprise polypropylene.

### Embodiment 16

The polyolefin master batch of embodiment 14, wherein the porous particles include a copolymer comprising a propylene monomer and an ethylene monomer.

### Embodiment 17

The polyolefin master batch of embodiment 14, wherein the porous particles include a copolymer comprising a propylene monomer and a butene monomer.

### Embodiment 18

The polyolefin master batch of embodiment 14, wherein the porous particles include polypropylene and a copolymer comprising a propylene monomer and an ethylene monomer.

### Embodiment 19

The polyolefin master batch of embodiment 14, wherein the porous particles include polypropylene and a copolymer comprising a propylene monomer and a butene monomer.

### Embodiment 20

The polyolefin master batch of any one of embodiments 14, 15, 18, or 19, wherein the porous particles are in the form of a reactor grade powder having a porosity of about 23% or greater.

### Embodiment 21

The polyolefin master batch of any one of embodiments 14-20, wherein the porous particles comprise thermoplastic particles.

### Embodiment 22

The polyolefin master batch of any one of embodiments 14-21, wherein the porous particles have a porosity of about 15% to about 35%.

### Embodiment 23

The polyolefin master batch of any one of embodiments 14-21, wherein the porous particles have a porosity of about 15% to about 25%.

### Embodiment 24

The polyolefin master batch of any one of embodiments 14-21, wherein the porous particles have a porosity of about 20% to about 25%.

### Embodiment 25

The polyolefin master batch of any one of embodiments 14-24, wherein the organosilane comprises a vinylsilane.

### Embodiment 26

The polyolefin master batch of any one of embodiments 14-25, wherein the organosilane comprises DYNASYLAN® 9116 (Evonik, USA) liquid vinylsilane.

### Embodiment 27

The polyolefin master batch of any one of embodiments 14-26, wherein the porous particles comprise substantially spherical particles.

### Embodiment 28

The polyolefin master batch of any one of embodiments 14-27, wherein the porous particles comprise HIFAX® CA 7153S (LyondellBasell Industries, USA) carrier resin.

In the descriptions provided herein, the terms “includes,” “is,” “containing,” “having,” and “comprises” are used in an open-ended fashion, and thus should be interpreted to mean “including, but not limited to.” When methods or polyolefin master batches are claimed or described in terms of “comprising” various components or steps, the methods or polyolefin master batches can also “consist essentially of” or “consist of” the various components or steps, unless stated otherwise.

The terms “a,” “an,” and “the” are intended to include plural alternatives, e.g., at least one. For instance, the disclosure of “an organosilane,” “a copolymer,” “a butene monomer”, and the like, is meant to encompass one, or mixtures or combinations of more than one organosilane, copolymer, butene monomer, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in some embodiments, that the porous particles have a porosity of about 15% to about 35%. This disclosure should be interpreted as encompassing percentages of about 15% to about 35%, and further encompasses “about” each of 16%, 17%, 18%, 19%, 20%, 21%, 22%, 23%, 24%, 25%, 26%, 27%, 28%, 29%, 30%, 31%, 32%, 33%, and 34%, including any ranges and sub-ranges between any of these values.

### EXAMPLES

The present invention(s) is/are further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention(s) will be apparent to those skilled in the art from consideration of the specification and practice of the invention(s) disclosed herein.

### Example 1—Production of a Polyolefin Master Batch

A polyolefin master batch was produced by mixing DYNASYLAN® 9116 (Evonik, USA) liquid vinylsilane and HIFAX® CA 7153S (LyondellBasell Industries, USA) carrier resin (i.e., a porous random polypropylene copolymer (C2, <4%).

The HIFAX® CA 7153S was a relatively hard polypropylene sphere having little or no apparent fines, and a porosity of about 23%. The HIFAX® CA 7153 S did not require an additional manufacturing step to introduce porosity.

The components were tumbled and gently heated to a number of temperatures less than 150° F. to produce a polyolefin master batch that included about 20%, by weight, of the vinylsilane, based on the weight of the polyolefin master batch. The vinylsilane was readily adsorbed.

The polyolefin master batch then was used to provide scorch retardancy to reactor grade ethylene vinylsilane in moisture-induced crosslinking systems. No liquid buildup was observed in the feed throat of the satellite extruder when deployed.

For comparison purposes, a similar test was conducted with XP400 LDPE (3M, Germany), and severe liquid build up was observed, which flooded the feed throat. A comparison of the results obtained with each carrier resin is provided at Table 1:

TABLE 1
Results Obtained with XP400 LDPE and HIFAX ® CA
7153S Porous Polypropylene

| Property | XP400 LDPE | HIFAX ® CA 7153S |
|---|---|---|
| Porosity | 65% (post-reactor foamed) | 23% (reactor spheres) |
| Melting Point | 108 | 143 |
| (° C.) | | |
| Pellet | Soft, friable pellet with | Tough, reactor spheres |
| Configuration | large amount of fines | |
| Conveying/ | Poor (required 1100 rpm | Excellent (required 500 |
| Transferring | to deliver 60 pphr) | rpm to deliver 60 pphr) |
| Liquid build-up | Severe | None |
| in feed throat | | |
| Quantification | Addition of phosphite | Polypropylene provided |
| Method | tracer* | tracer peak |

*Done because the silane scorch retardant masterbatch was added into the EVS, which has silane.

We claim:

1. A method of forming a polyolefin master batch, the method comprising:
providing a mixture, wherein the mixture comprises an organosilane and porous particles; and
heating the mixture at a temperature effective to adsorb at least a portion of the organosilane to one or more surfaces of the porous particles to form the polyolefin master batch;
wherein the organosilane is present in the polyolefin master batch in an amount ranging from about 10% to about 50% by weight of the polyolefin master batch, and the porous particles comprise [1] polypropylene, [2] a copolymer comprising (i) a propylene monomer and (ii) at least one of an ethylene monomer and a butene monomer, or [3] a combination thereof.

2. The method of claim 1, wherein the porous particles are in the form of a reactor grade powder having a porosity (% vol.) of about 23% or greater.

3. The method of claim 1, wherein the porous particles have a porosity (% vol.) of about 15% to about 50%.

4. The method of claim 1, wherein the porous particles have a porosity (% vol.) of about 15% to about 35%.

5. The method of claim 1, wherein the porous particles have a porosity (% vol.) of about 15% to about 25%.

6. The method of claim 1, wherein the porous particles have a melt flow rate of about 5 g/10 minutes to about 20 g/10 minutes.

7. The method of claim 1, wherein the organosilane is present in the polyolefin master batch in an amount ranging from about 10% to about 40% by weight of the polyolefin master batch.

8. The method of claim 1, wherein the organosilane is present in the polyolefin master batch in an amount ranging from about 10% to about 30% by weight of the polyolefin master batch.

9. The method of claim 1, wherein the organosilane comprises a vinylsilane.

10. The method of claim 1, wherein the temperature effective to adsorb at least a portion of the organosilane to one or more surfaces of the porous particles is about 80° F. to about 150° F.

11. The method of claim 1, wherein the method further comprises tumbling the mixture.

12. A polyolefin master batch comprising:
porous particles and an organosilane adsorbed to the porous particles,
wherein the organosilane is present in an amount ranging from about 10% to about 50% by weight, based on the combined weight of the porous particles and the organosilane, and the porous particles comprise [1] polypropylene, [2] a copolymer comprising (i) a propylene monomer and (ii) at least one of an ethylene monomer and a butene monomer, or [3] a combination thereof.

13. The polyolefin master batch of claim 12, wherein the porous particles are in the form of a reactor grade powder having a porosity (% vol.) of about 23% or greater.

14. The polyolefin master batch of claim 12, wherein the porous particles comprise thermoplastic particles.

15. The polyolefin master batch of claim 12, wherein the porous particles have a porosity (% vol.) of about 15% to about 35%.

16. The polyolefin master batch of claim 12, wherein the porous particles have a porosity (% vol.) of about 15% to about 25%.

17. The polyolefin master batch of claim 12, wherein the porous particles have a melt flow rate of about 5 g/10 minutes to about 20 g/10 minutes.

18. The polyolefin master batch of claim 12, wherein the organosilane comprises a vinylsilane.

19. The polyolefin master batch of claim 12, wherein the porous particles comprise substantially spherical particles.

20. A polyolefin master batch comprising:
porous particles and vinylsilane adsorbed to the porous particles,
wherein the vinylsilane is present in an amount ranging from about 10% to about 50% by weight, based on the combined weight of the porous particles and the vinylsilane, and
wherein the porous particles have a porosity of about 15% to about 35%, and comprise a copolymer comprising (i) a propylene monomer and (ii) at least one of an ethylene monomer and a butene monomer.
